(19) United States
(12) Patent Application Publication
(10) Pub. No.: US 2016/0196906 A1
(43) Pub. Date: Jul. 7, 2016

(54) COIL-EMBEDDED SUBSTRATE AND METHOD OF MANUFACTURING THE SAME

(71) Applicant: Samsung Electro-Mechanics Co., Ltd., Suwon-si (KR)

(72) Inventors: Hong-Won KIM, Suwon-si (KR); Jeong-Min CHO, Seongnam-si (KR); Jin-Gu KIM, Suwon-si (KR)

(73) Assignee: Samsung Electro-Mechanics Co., Ltd., Suwon-si (KR)

(21) Appl. No.: 14/989,192

(22) Filed: Jan. 6, 2016

(30) Foreign Application Priority Data
Jan. 6, 2015 (KR) 10-2015-0001301

(51) Int. Cl. H01F 1/147; H01F 27/29; H01F 41/02; H01F 27/28

(52) U.S. Cl. CPC H01F 1/14708; H01F 27/2823; H01F 27/29; H01F 41/02

(57) ABSTRACT

A coil-embedded substrate and a method of manufacturing the same are provided. The coil-embedded substrate includes a substrate having a hollow portion disposed therein, a coil conductor disposed in the substrate and having a spiral shape winding about the hollow portion, a magnetic core disposed in the hollow portion, and a cover layer covering the substrate and the hollow portion.

### CROSS-REFERENCE TO RELATED APPLICATIONS

This application claims the benefit under 35 USC 119(a) of Korean Patent Application No. 10-2015-0001301 filed on Jan. 6, 2015 in the Korean Intellectual Property Office, the entire disclosure of which is incorporated herein by reference for all purposes.

### BACKGROUND

1. Field

The following description relates to a coil component, and to a coil component having an excellent efficiency of magnetic influx and a method of manufacturing the same.

2. Description of Related Art

Electronic devices such as mobile phones, home appliances, personal computers, personal digital assistants (PDA), liquid crystal displays (LCD) and GPS navigation devices are becoming increasingly digital and becoming faster. These electronic devices are sensitive to stimulation from outside, and any abnormal voltage and high-frequency noise from outside that are brought into the internal circuit of the electronic device, no matter how small, may destroy the circuit or distort signals.

The abnormal voltage and noise are often caused by a switching voltage generated within the circuit, a power noise included in power voltage, an unnecessary electromagnetic signal from the environment or an electromagnetic noise. Coil components are often used to prevent the flow of abnormal voltage and high-frequency noise into the circuit.

For instance, unlike general single-ended transmission systems, high-speed interfaces, such as USB 2.0, USB 3.0 and high-definition multimedia interface (HDMI), adopt a differential signal system transmitting differential signals (differential mode signals) using a pair of signal lines, and common mode filters (CMF) are used as the coil component for removing common mode noises in the differential signal transmission system.

In the general structure of a conventional CMF, a coil layer is formed over a ferrite substrate in which magnetic powder is sintered, and a ferrite resin composite for protecting the coil layer and preventing a leakage of magnetic flux is laminated on the coil layer.

The ferrite resin composite, which is made by mixing magnetic powder with resin, has a significantly smaller magnetic permeability than the ferrite substrate underneath because the magnetic powder is dispersed in the resin, thereby lowering the performance efficiency of the CMF device.

As such, since the conventional CMF has the structural limitation of lowered efficiency of magnetic flux passing through the central, coil layer by the upper, ferrite resin composite, there are a number of studies underway to increase the magnetic permeability of the ferrite resin composite in order to improve the performance of the CMF.

Meanwhile, because an insulation layer having a coil installed therein is formed over a highly brittle, ceramic type of ferrite substrate, delamination or crack may occur between the insulation layer and the ferrite substrate.

As one of the measures taken to improve the low magnetic permeability resulting from the ferrite resin composite, the number of turns of the coil is increased by implementing a finer pitch. However, this measure requires additional semiconductor processes and materials, inevitably resulting in an increase in manufacturing cost. An example of a CMF is disclosed in Published Japan Patent Application 2014-107435.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a coil-embedded substrate includes a substrate having a hollow portion disposed therein, a coil conductor disposed in the substrate and having a spiral shape winding about the hollow portion, a magnetic core disposed in the hollow portion, and a cover layer covering the substrate and the hollow portion.

The magnetic core may include at least one of magnetic materials selected from the group consisting of Ni-based ferrite, Ni—Zn ferrite and Ni—Zn—Cu ferrite.

A size of the magnetic core may correspond to a size of the hollow portion, or a width of the magnetic core may be smaller than a width of the hollow portion.

The magnetic core may have a circular cylindrical shape or a rectangular cylindrical shape.

The coil conductor may include a first coil conductor and a second coil conductor electromagnetically coupled with each other.

The cover layer may include a polymer resin.

The cover layer may further include magnetic powder mixed in the polymer resin.

The general aspect of the coil-embedded substrate may further include an external terminal disposed on the cover layer and electrically connected to the coil conductor.

In another general aspect, a method of manufacturing a coil-embedded substrate may involve forming a substrate with a coil conductor disposed therein, forming a hollow portion that penetrates the substrate in a center portion of the coil conductor, inserting a magnetic core into the hollow portion, and forming a cover layer above and below the substrate having the hollow portion included therein.

The general aspect of the method may further involve attaching a support member on one surface of the substrate prior to inserting the magnetic core, and the cover layer may be formed by forming a first cover layer on the other surface of the substrate and forming a second cover layer on the one surface of the substrate after removing the support member from the one surface of the substrate.

In another general aspect, a coil-embedded substrate may include a magnetic core disposed in a substrate, a coil conductor surrounding the magnetic core and disposed in the substrate, and a cover layer including an upper insulating layer disposed on a top surface of the substrate and a lower insulating layer disposed on a bottom surface of the substrate such that the magnetic core and the coil conductor are embedded in the coil-embedded substrate.

The coil conductor may include a spiral structure aligned along a plane parallel to a bottom surface of the substrate.

The magnetic core may be disposed substantially in a center of the spiral structure of the coil conductor.

The coil conductor may form a circular donut shape with the magnetic core disposed in a donut hole of the circular donut shape.

The coil conductor may form a rectangular donut shape with the magnetic core disposed in a donut hole of the rectangular donut shape.

Other features and aspects will be apparent from the following detailed description, the drawings, and the claims.

### BRIEF DESCRIPTION OF DRAWINGS

FIG. 1 is a perspective view of an example of a coil-embedded substrate.

FIG. 2 is a cross-sectional view of the coil-embedded substrate illustrated in FIG. 1 along line I-I′.

FIGS. 3 and 4 are top views of examples of magnetic cores.

FIG. 5 is a cross-sectional view of another example of a coil-embedded substrate.

FIG. 6 is a flow diagram of an example of a method of manufacturing a coil-embedded substrate.

FIGS. 7 to 13 are cross-sectional views illustrating steps of the method of manufacturing a coil-embedded substrate illustrated in FIG. 6.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

The terms used in the description are intended to describe certain embodiments only, and shall not be construed to limit the present description. Unless clearly used otherwise, expressions in a singular form include the meaning of a plural form. Any characteristic, number, step, operation, element, part or combinations thereof used in the present description shall not be construed to preclude any presence or possibility of one or more other characteristics, numbers, steps, operations, elements, parts or combinations thereof.

Unless indicated otherwise, a statement that a first layer is “on” a second layer or a substrate is to be interpreted as covering both a case where the first layer directly contacts the second layer or the substrate, and a case where one or more other layers are disposed between the first layer and the second layer or the substrate.

Words describing relative spatial relationships, such as “below”, “beneath”, “under”, “lower”, “bottom”, “above”, “over”, “upper”, “top”, “left”, and “right”, may be used to conveniently describe spatial relationships of one device or elements with other devices or elements. Such words are to be interpreted as encompassing a device oriented as illustrated in the drawings, and in other orientations in use or operation.

The elements shown in the drawings are not necessarily illustrated to the exact scale. For instance, some elements of the drawings may be exaggerated over other elements, for better understanding of a certain embodiment of the present description. Same reference numerals in different figures may refer to the same element, and similar reference numerals may refer, although not necessarily always, to similar elements. For a simpler and clear illustration, the drawings are illustrated with a generally practiced way of arrangement, and any known features and description may be omitted in order to avoid making a discussion of the described embodiments of the present description unnecessarily ambiguous.

Hereinafter, certain embodiments of the present description will be described in detail with reference to the accompanying drawings.

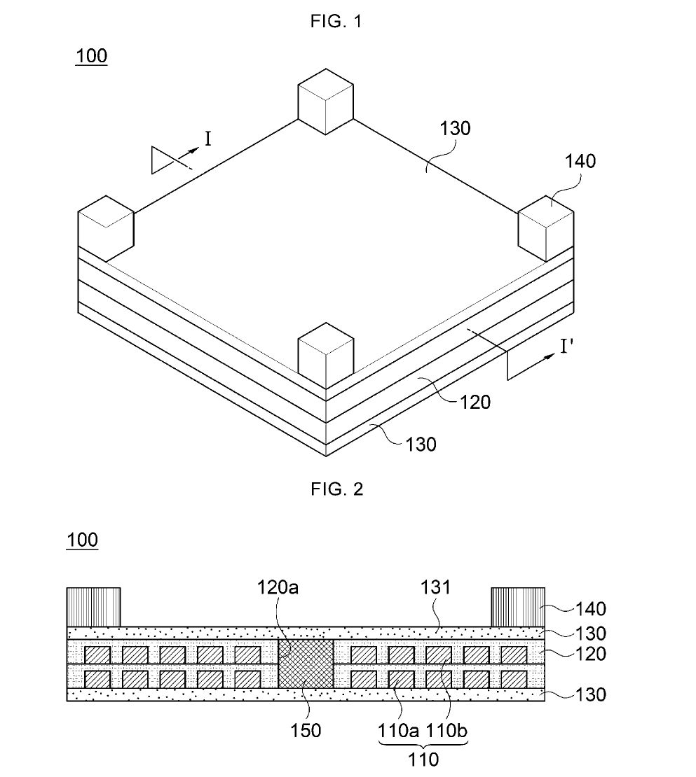

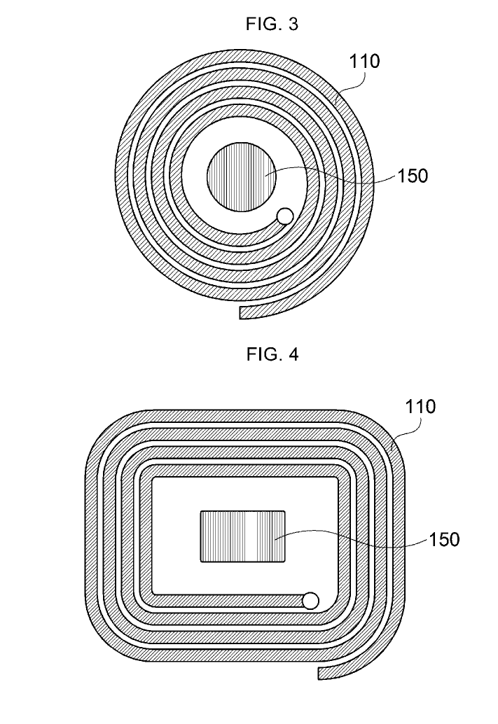

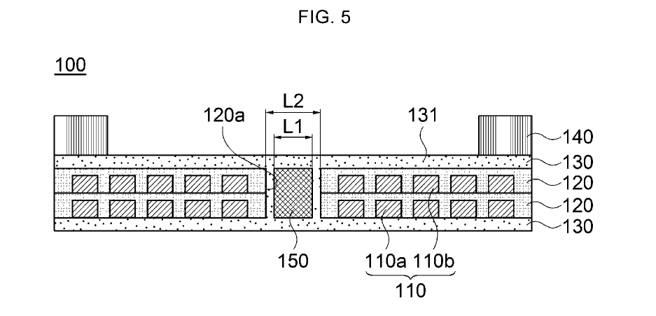

FIG. 1 illustrates a perspective view of an example of a coil-embedded substrate in accordance with the present description, and FIG. 2 illustrates a cross-sectional view of the coil-embedded substrate shown in FIG. 1 along the I-I′ line. FIGS. 3 and 4 illustrate top views of examples of magnetic cores in accordance with the present description.

Referring to FIGS. 1 and 2, a coil-embedded substrate 100 in accordance with an example of the present description includes a substrate 120 having a coil conductor 110 installed therein and cover layers 130 formed to cover upper and lower sides of the substrate 120, respectively.

The substrate 120 may be an insulation member made of a ceramic or the like. In this example, the substrate 120 provides flatness to a base surface of the coil conductor 110 and protects the coil conductor 110 from an outside.

Accordingly, the substrate 120 may be made of a material having good heat-resisting and moisture-resisting properties as well as an insulating property. For example, the substrate 120 may be made of a glass epoxy substrate, polyester substrate, polyimide substrate, BT resin substrate or thermosetting polyphenylene ether substrate.

The substrate 120 may be formed in a single layer or in a multilayered substrate in which a plurality of layers are laminated in a thickness direction. In the case where the substrate 120 is a multilayered substrate, the coil conductor 110 may be installed in every layer.

The substrate 120 has a hollow portion 120a formed therein, and the coil conductor 110 is spirally installed about the hollow portion 120a. That is, the coil conductor 110, which is a coil pattern of metal wiring that is plated to wind on a plane about the hollow portion 120a, may be made of at least one of highly electrically conductive metal selected from the group consisting of silver (Ag), palladium (Pd), aluminum (Al), nickel (Ni), titanium (Ti), gold (Au), copper (Cu) and platinum (Pt).

In an example in which the coil conductor 110 is configured in multiple layers, the coil conductor 110 on each layer may be separated by a predetermined distance and disposed to face opposite to each other to form a coil by making an interlayer connection through a via or other connecting members.

Referring to FIG. 2, the coil conductor 110 is constituted with a first coil conductor 110a and a second coil conductor 110b that are electromagnetically coupled with each other and are each formed as an individual coil.

For instance, referring to FIG. 2, the coil conductor 110 formed on a lower layer is the first coil conductor 110a, and the coil conductor 110 formed on an upper layer is the second coil conductor 110b. However, the present description is not limited thereto. In another example, it is also possible that the first coil conductor 110a and the second coil conductor 110b are alternately disposed on a same plane to have the first coil conductor 110a and the second coil conductor 110b installed together on a same layer.

As such, in an example in which the first coil conductor 110a and the second coil conductor 110b are electromagnetically coupled with each other, the coil-embedded substrate 100 operates as a common mode filter (CMF) in which the magnetic flux is reinforced. and a common mode impedance is increased if a current is applied to the first coil conductor 110a and the second coil conductor 110b in a same direction and in which the magnetic flux is canceled out and a differential mode impedance is decreased if the current is applied to the first coil conductor 110a and the second coil conductor 110b in opposite directions.

The coil conductor 110 is electrically connected with external terminals 140 disposed on one surface of the cover layer 130 through vias or other connecting member, and the external terminals 140 are connected with an external circuit through a conductive adhesive or the like as a medium. Through this electrical connection structure, a current provided from an outside is applied to the coil conductor 110 through the external terminals 140.

As described above, because the coil conductor 110 is constituted with the first coil conductor 110a and the second coil conductor 110b forming their respective individual coils, there may be four external terminals 140 consisting of a pair of external terminals 140 connected to either end of the first conductive coil 110a and functioning, respectively, as input and output terminals of the first conductive coil 110a and a pair of external terminals 140 connected to either end of the second conductive coil 110b and functioning, respectively, as input and output terminals of the second conductive coil 110b. In this example, the external terminals 140 are disposed, respectively, near four corners of the substrate 120, in a clockwise or counterclockwise direction from an upper left corner of the substrate 120.

The hollow portion 120a has a magnetic core 150 disposed therein for improvement of magnetic permeability.

Since the magnetic flux generated in response to the application of current flows while forming a closed magnetic circuit around the coil conductor 110, placing the magnetic core 150 in the middle of the coil conductor 110 through which the magnetic flux passes reinforces the magnetic flux and improves the CMF performance.

Accordingly, the magnetic core 150 may be made of any magnetic material as long as a predetermined inductance may be obtained. For example, for a better magnetic permeability, the material constituting the magnetic core 150 may be a Ni-based ferrite material having Fe₂O₃ and NiO as main components, a Ni—Zn ferrite material having Fe₂O₃, NiO and ZnO as main components, or a Ni—Zn—Cu ferrite material having Fe₂O₃, NiO, ZnO and CuO as main components.

The magnetic core 150 may be formed in a bulk type or formed by sintering a plurality of laminated ferrite sheets. In this example, the magnetic core 150 is formed to have a size that corresponds to a size of the hollow portion 120a such that the magnetic flux may pass through a wider area of the magnetic core 150.

According to one example, the magnetic core 150 has a same shape as that of the hollow portion 120a. For example, if the hollow portion 120a is formed in a circular cylindrical shape or a rectangular cylindrical shape, the magnetic core 150 may be also formed in the circular cylindrical shape or rectangular cylindrical shape, with substantially the same width and height as that of the hollow portion 120a.

Moreover, since a greater amount of magnetic flux can pass through the magnetic core 150 if a distance between the magnetic core 150 and an innermost pattern of the coil conductor 110 is closer, the magnetic core 110 may be formed to go around the magnetic core 150. Therefore, if the magnetic core 150 has a circular cylindrical shape, the coil conductor 110 is formed in a circular spiral shape as shown in FIG. 3. The overall shape of the circular spiral may be described as a donut shape, or a circular disk shape with a hole in the middle, with the magnetic core 150 positioned in the donut hole. If the magnetic core 150 has a rectangular cylindrical shape, the coil conductor 110 is formed in a rectangular spiral shape as shown in FIG. 4. The overall shape of the rectangular spiral may be a rectangular donut shape, or a rectangular board shape with a hole in the middle. The coil conductor 110 having a spiral shape may have a planar bottom surface with a plurality of revolution of the coil aligned along a bottom surface of the substrate 120, as shown in FIG. 2. In the example illustrated in FIGS. 3 and 4, a magnetic core 150 having a cylindrical shape is paired with a coil conductor 110 having a circular spiral shape, and a magnetic core 150 having a rectangular shape is paired with a coil conductor 110 having a rectangular spiral shape. However, variations are possible in other examples.

The cover layer 130 is formed to bury the substrate 120 having the coil conductor 110 embedded therein as well as the magnetic core 150, and thus functions to protect the substrate 120 and the magnetic core from an outside.

Therefore, the cover layer 130 may be made of a material having good heat-resisting and moisture-resisting properties as well as an insulating property. For example, the cover layer 130 may be made of epoxy resin, phenol resin, urethane resin, silicon resin or polyimide resin.

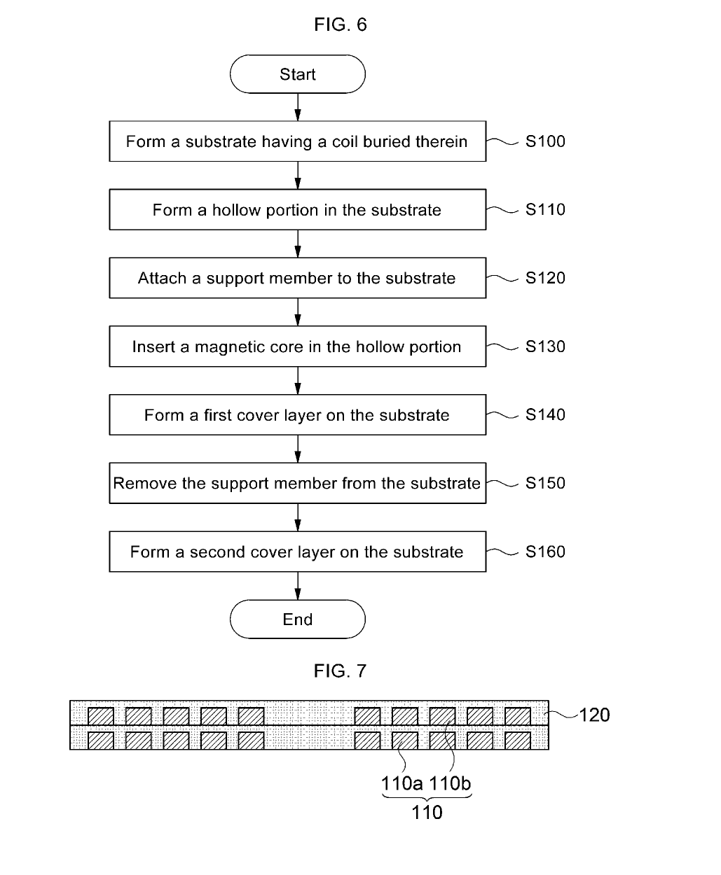

FIG. 5 illustrates a cross-sectional view of another example of a coil-embedded substrate in accordance with the present description. In this example, the magnetic core 150 is formed to be smaller than the hollow portion 120a. Specifically, a width L1 of the magnetic core 150 is smaller than a width L2 of the hollow portion 120a.

In such a case, the magnetic core 150 may be readily inserted into the hollow portion 120a, thereby improving a production yield.

Moreover, as the magnetic core 150 is separated from an inner wall of the hollow portion 120a with a predetermined gap and the cover layer 130 fills up the gap between the magnetic core 150 and the hollow portion, an adhesive strength between the substrate 120 and the cover layer 130 and between the magnetic core 150 and the cover layer 130 may be enhanced.

As such, by burying the substrate 120 therein, the cover layer 130 is in contact with upper and lower surfaces of the substrate 120 as well as the inner wall of the hollow portion 120a. To enhance the adhesive strength, the cover layer 130 may be made of highly adhesive polymer resin, such as epoxy resin, phenol resin, urethane resin, silicon resin or polyimide resin.

Alternatively, in another example, in order to prevent a leakage of magnetic flux, the cover layer 130 may be made of a material in which magnetic powder 131 is dispersed in the polymer resin composite. Like the magnetic core 150, the magnetic powder 131 may be made of at least one of magnetic materials selected from the group consisting of Ni-based ferrite, Ni—Zn ferrite and Ni—Zn—Cu ferrite.

The higher the content of the magnetic powder 131, the higher the magnetic permeability is, but the amount of resin is reduced by as much, possibly deteriorating the adhesive properties of the cover layer 130. Therefore, according to one example, the mixing ratio of the magnetic powder 131 is properly adjusted to form the cover layer 130.

As described above, by introducing the magnetic core 150 in the middle of the coil conductor 110 as well as the cover layer 130 having the magnetic powder 131 contained therein, the magnetic flux may be increased, and thus the cost for manufacturing a fine pattern may be saved because the number of turns in the coil pattern does not have to be excessively increased.

Hereinafter, an example of a method of manufacturing a coil-embedded substrate will be described in detail with reference to the accompanying drawings.

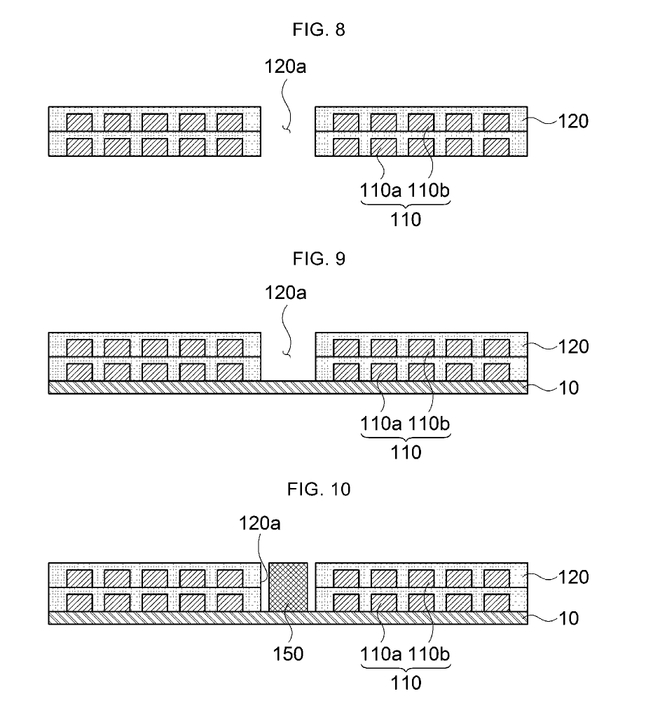

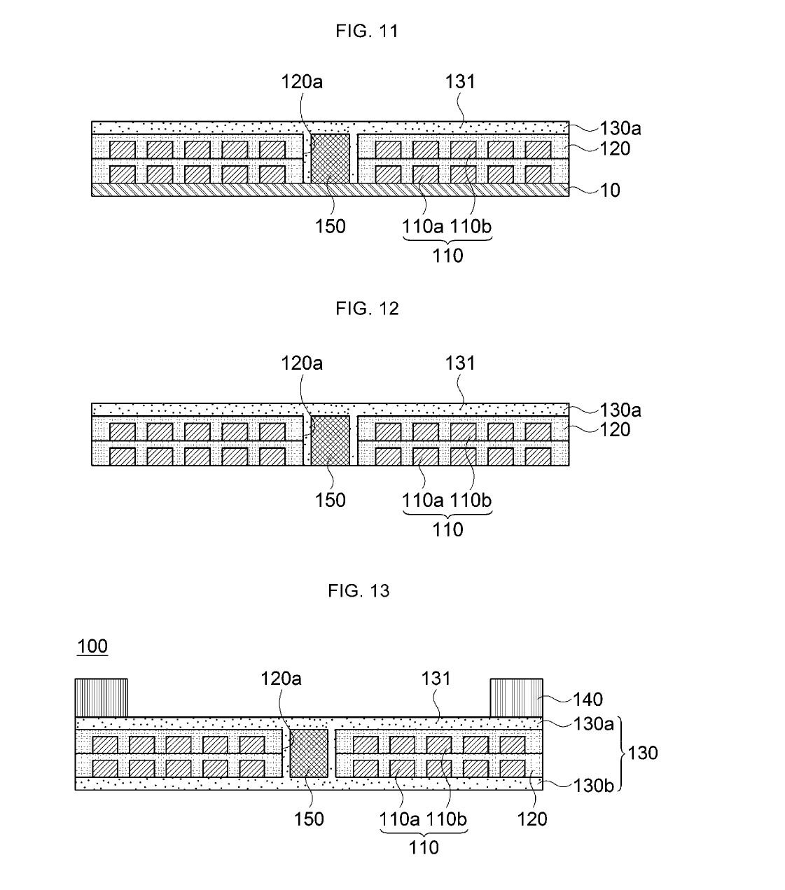

FIG. 6 illustrates a flow diagram of an example of a method of manufacturing a coil-embedded substrate in accordance with the present description, and FIGS. 7 to 13 illustrate the respective steps of the method of manufacturing a coil-embedded substrate shown in FIG. 6.

The method of manufacturing a coil-embedded substrate in accordance with the present description starts with forming a substrate 120 having a coil conductor 110 buried therein (S100) as illustrated in FIG. 7.

The substrate 120 may be made of glass epoxy substrate, polyester substrate, polyimide substrate, BT resin substrate or thermosetting polyphenylene ether substrate, and may be formed to have the coil conductor 110 buried therein using a plating process known in the art to which the present description pertains. For example, the substrate 120 may be formed to have the coil conductor 110 buried therein by using a semi-additive process (SAP), a modified semi-additive process (MSAP) or a subtractive process.

Then, referring to FIG. 8, a hollow portion 120a is formed in the substrate 120 in such a way that the hollow portion 120a penetrates a center portion of the coil conductor 110.

The hollow portion 120a may be processed using a laser drill, for example a YAG laser or a CO₂ laser, or a mechanical drill such as a CNC drill. After the drilling process, a deburring process may be carried out to remove a burr, which occurs during the drilling process, and dust on an inner wall of the hollow portion 120a.

In this example, the shape of the hollow portion 120a may be determined based on a spiral shape of the coil conductor 110. For instance, in the case where the coil conductor 110 is formed in a circular spiral shape, the hollow portion 120a is process to have a circular planar shape.

Next, a magnetic core 150 is inserted in the hollow portion 150.

To insert the hollow portion 150, as shown in FIG. 9, one side of the hollow portion 120a is closed off by attaching a support member 10 to one surface of the substrate 120 (S120). Then, the magnetic core 150 is inserted into the hollow portion 120a in such a way that the magnetic core 150 is supported on the support member 10 (S130), as illustrated in FIG. 10.

For example, the support member 10, which holds the magnetic core 150 firmly to fix the position thereof, may be made of an adhesive tape or an adhesive film that may be readily attached and peeled off.

Afterwards, a cover layer 130 is formed above and below the substrate 120, including the areas above and below the hollow portion 120a.

Specifically, referring to FIG. 11, a paste is coated or a film is laminated on the other surface of the substrate 120, that is, an opposite surface of the one surface of the substrate 120 to which the support member 10 is attached, to form a first cover layer 130a having a hollow space of the hollow portion 120a and an upper portion of the substrate 120 buried therein (S140).

The first cover layer 130a may be fully hardened or semi-hardened enough to have the magnetic core 150 fixed thereto and may be made of highly adhesive polymer resin, such as epoxy resin, phenol resin, urethane resin, silicon resin or polyimide resin, or the polymer resin mixed with magnetic powder 131 such as Ni-based ferrite, Ni—Zn ferrite or Ni—Zn—Cu ferrite, for example.

Then, referring to FIG. 12, the support member 10 is removed (S150), and referring to FIG. 13, a paste is coated or a film is laminated on the one surface of the substrate 120, that is, the surface of the substrate 120 from which the support member 10 is removed, to form a second cover layer 130b having a lower portion of the substrate 120 buried therein (S160).

The second cover layer 130b may be made of a same material as that of the first cover layer 13a and may be fired and fully hardened under a predetermined condition (e.g., temperature of 150 to 300° C. and pressure of 1 to 50 Kg/cm²).

Once the firing is finished, the first cover layer 130a and the second cover layer 130b are integrated such that a boundary thereof is unidentifiable. As a result, the substrate 120 becomes buried by the cover layer 130, which constitutes both the first cover layer 130a and the second cover layer 130b.

Lastly, by forming an external terminal 140 on one surface of the cover layer 130, a coil-embedded substrate 100 in accordance with an example of the present description is completed.

The example of the coil-embedded substrate has a magnetic core with a high magnetic permeability inserted in a location where magnetic flux passes. Thus, the magnetic permeability of the coil-embedded substrate may be increased.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A coil-embedded substrate comprising:
a substrate having a hollow portion disposed therein;
a coil conductor disposed in the substrate and having a spiral shape winding about the hollow portion;
a magnetic core disposed in the hollow portion; and
a cover layer covering the substrate and the hollow portion.

2. The coil-embedded substrate as set forth in claim 1, wherein the magnetic core comprises at least one of magnetic materials selected from the group consisting of Ni-based ferrite, Ni—Zn ferrite and Ni—Zn—Cu ferrite.

3. The coil-embedded substrate as set forth in claim 1, wherein a size of the magnetic core corresponds to a size of the hollow portion, or a width of the magnetic core is smaller than a width of the hollow portion.

4. The coil-embedded substrate as set forth in claim 1, wherein the magnetic core has a circular cylindrical shape or a rectangular cylindrical shape.

5. The coil-embedded substrate as set forth in claim 1, wherein the coil conductor comprises a first coil conductor and a second coil conductor electromagnetically coupled with each other.

6. The coil-embedded substrate as set forth in claim 1, wherein the cover layer comprises a polymer resin.

7. The coil-embedded substrate as set forth in claim 6, wherein the cover layer further comprises magnetic powder mixed in the polymer resin.

8. The coil-embedded substrate as set forth in claim 1, further comprising an external terminal disposed on the cover layer and electrically connected to the coil conductor.

9. A method of manufacturing a coil-embedded substrate, comprising:
forming a substrate with a coil conductor disposed therein;
forming a hollow portion that penetrates the substrate in a center portion of the coil conductor;
inserting a magnetic core into the hollow portion; and
forming a cover layer above and below the substrate having the hollow portion included therein.

10. The method as set forth in claim 9, further comprising attaching a support member on one surface of the substrate prior to inserting the magnetic core,
wherein the cover layer is formed by forming a first cover layer on the other surface of the substrate and forming a second cover layer on the one surface of the substrate after removing the support member from the one surface of the substrate.

11. A coil-embedded substrate comprising:
a magnetic core disposed in a substrate;
a coil conductor surrounding the magnetic core and disposed in the substrate; and
a cover layer comprising an upper insulating layer disposed on a top surface of the substrate and a lower insulating layer disposed on a bottom surface of the substrate such that the magnetic core and the coil conductor are embedded in the coil-embedded substrate.

12. The coil-embedded substrate as set forth in claim 11, wherein the coil conductor comprises a spiral structure aligned along a plane parallel to a bottom surface of the substrate.

13. The coil-embedded substrate as set forth in claim 12, wherein the magnetic core is disposed substantially in a center of the spiral structure of the coil conductor.

14. The coil-embedded substrate as set forth in claim 11, wherein the coil conductor has a circular donut shape with the magnetic core disposed in a donut hole of the circular donut shape.

15. The coil-embedded substrate as set forth in claim 11, wherein the coil conductor has a rectangular donut shape with the magnetic core disposed in a donut hole of the rectangular donut shape.
